(19) United States
(12) Patent Application Publication
(10) Pub. No.: US 2015/0271979 A1
(43) Pub. Date: Oct. 1, 2015

(54) Weed Extraction Tool Device

(71) Applicant: Fritz Mutter, Arcadia, CA (US)

(72) Inventor: Fritz Mutter, Arcadia, CA (US)

(21) Appl. No.: 14/227,687

(22) Filed: Mar. 27, 2014

(51) Int. Cl. A01B 1/16

(52) U.S. Cl. CPC A01B 1/16

(57) ABSTRACT

A weed extraction tool device quickly and easily extracts a weed by its roots. The device includes an elongated shaft having a first end and a second end. A handle is coupled to the first end of the shaft. A blade is coupled to the second end of the shaft. The blade is configured for being inserted into a ground surface for removing weeds from the ground surface. A leverage member is coupled to and extends outwardly from a rear end of the shaft. The leverage member is positioned below the handle and above the blade. The leverage member is configured to abut the ground surface to provide leverage for facilitating extraction of the weeds from the ground surface. The blade is angled downwardly and forwardly away from the shaft in a direction away from the leverage member.

### BACKGROUND OF THE DISCLOSURE

### Field of the Disclosure

The disclosure relates to weed extraction apparatuses and more particularly pertains to a new weed extraction apparatus for quickly and easily extracting a weed by its roots.

### SUMMARY OF THE DISCLOSURE

An embodiment of the disclosure meets the needs presented above by generally comprising an elongated shaft having a first end and a second end. A handle is coupled to the first end of the shaft. A blade is coupled to the second end of the shaft. The blade is configured for being inserted into a ground surface for removing weeds from the ground surface. A leverage member is coupled to and extends outwardly from a rear end of the shaft. The leverage member is positioned below the handle and above the blade. The leverage member is configured to abut the ground surface to provide leverage for facilitating extraction of the weeds from the ground surface. The blade is angled downwardly and forwardly away from the shaft in a direction away from the leverage member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top rear side perspective view of a weed extraction tool device according to an embodiment of the disclosure.

FIG. 2 is a bottom view of an embodiment of the disclosure.

FIG. 3 is a side view of an embodiment of the disclosure.

FIG. 4 is a back view of an embodiment of the disclosure.

FIG. 5 is a side view of an embodiment of the disclosure in use.

### DESCRIPTION OF THE PREFERRED EMBODIMENT

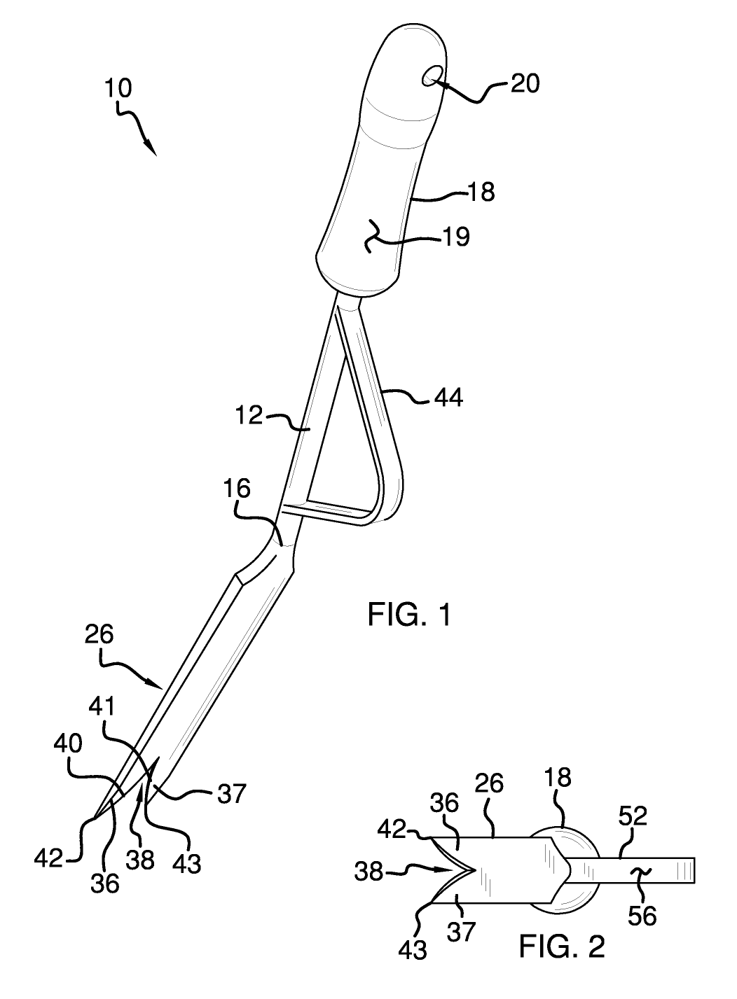

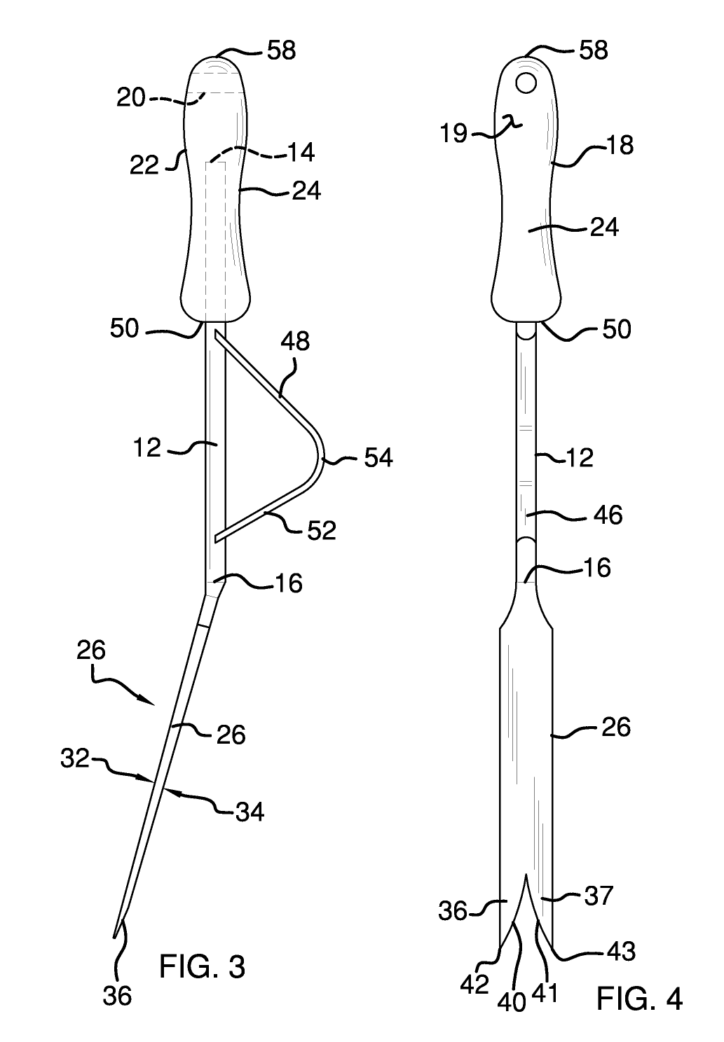

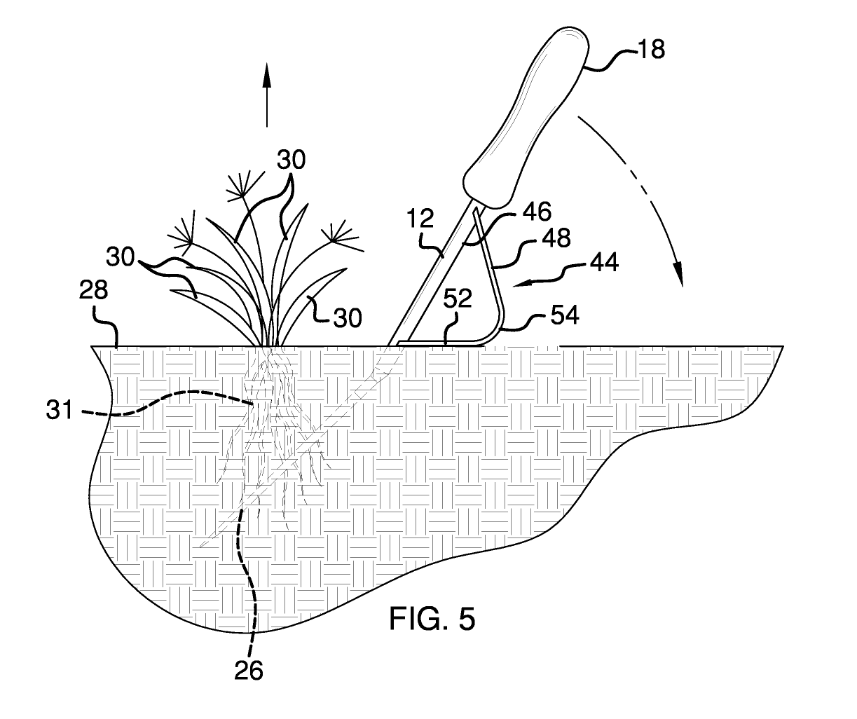

With reference now to the drawings, and in particular to FIGS. 1 through 5 thereof, a new weed extraction apparatus embodying the principles and concepts of an embodiment of the disclosure and generally designated by the reference numeral 10 will be described.

As best illustrated in FIGS. 1 through 5, the weed extraction tool device 10 generally comprises an elongated shaft 12 having a first end 14 and a second end 16. A handle 18 is coupled to the first end 14 of the shaft 12 and may be done so either integrally or attached via an adhesive, welding, or some other conventional fastening means. The handle 18 may be constructed from plastic or like material. The handle 18 may have a channel 20 extending therethrough between a front surface 22 and a rear surface 24 of the handle 18. The channel 20 is configured to facilitate hanging of the device 10 on a support member, such as a nail, hook or the like. A perimeter surface 19 of the handle 18 may have sections of varying diameter. The handle 18 may have a length extending between a top end 58 of the handle 18 and a bottom end 50 of the handle 18 that measures between approximately 12.0 cm and 18.0 cm.

A blade 26 is coupled to the second end 16 of the shaft 12. The blade 26 is configured for being inserted into a ground surface 28 for removing weeds 30 from the ground surface 28. The blade 26 may be integrally coupled to the shaft 12 or may be attached via welding, an adhesive or the like. The blade 26 may have a planar upper surface 32 and a planar lower surface 34. The blade 26 includes a plurality of spaced projections 36, 37 positioned distally relative to shaft 12. As shown in the Figures, there may be exactly two spaced projections 36, 37 though it should be understood that more spaced projections 36, 37 may be included. The spaced projections 36, 37 define a notch 38 extending between the spaced projections 36, 37. Each of the spaced projections 36, 37 has a respective inner lateral edge 40, 41 that may be convexly arcuate. Each of the plurality of spaced projections 36, 37 has a distal end 42, 43 with respect to the shaft 12. Each of the spaced projections 36, 37 may taper outwardly toward a respective one of the distal ends 42 43. Each of the distal ends 42, 43 may be pointed. The device 10 may have a length extending between the top end 58 of the handle 18 and the distal ends 42, 43 of the spaced projections 36, 37 that measures between approximately 25.0 cm and 55.0 cm.

A leverage member 44 is coupled to and extends outwardly from a rear end 46 of the shaft 12. The leverage member 44 is positioned below the handle 18 and above the blade 26. The leverage member 44 is configured to abut the ground surface 28 to provide leverage for facilitating extraction of the weeds 30 from the ground surface 28. The leverage member 44 may be v-shaped and define a first section 48 coupled to the shaft 12 proximate the bottom end 50 of the handle 18, a second section 52 coupled to the shaft 12 proximate the second end 16 of the shaft 12, and a juncture 54 coupled to and extending between the first section 48 and the second section 52. An outer surface 56 of the second section 52 is planar to permit the second section 52 to lie flat on the ground surface 28. In this manner, the second section 52 functions as a fulcrum of a lever to assist in extraction of the weeds 30 from the ground surface 28. In particular, the juncture 54 may be arcuate to facilitate pivotal movement of the device 10 while being used to extract weeds 30 from the ground surface 28. The blade 26 is angled downwardly and forwardly away from the shaft 12 in a direction away from the leverage member 44. The shaft 12, the blade 26 and the leverage member 44 are each constructed from a durable rigid material such as steel or the like.

In use, as stated above and shown in the Figures, the blade 26 is inserted into a ground surface 28 proximate weeds 30 to be pulled such that the rear end 46 of the shaft 12 is positioned at angle of approximately 45 degrees with respect to the ground surface 28. The second section 52 of the leverage member 44 is positioned flush against the ground surface 28. The spaced projections 36 are positioned approximately 10.0 cm to 13.0 cm below a center of the roots 31 of a plant 33. A user grasps onto the handle 18 and pulls backward on the device 10 such that the leverage member 44 acts as a fulcrum upon the ground surface 28. This causes both the weeds 30 and roots 31 of the plant 33 to be extracted from the ground surface 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed extraction tool device comprising:
an elongated shaft having a first end and a second end;
a handle coupled to said first end of said shaft;
a blade coupled to said second end of said shaft; said blade being configured for being inserted into a ground surface for removing weeds from the ground surface;
a leverage member coupled to and extending outwardly from a rear end of said shaft, said leverage member being positioned below said handle and above said blade, said leverage member being configured to abut the ground surface to provide leverage for facilitating extraction of the weeds from the ground surface; and
wherein said blade is angled downwardly and forwardly away from said shaft in a direction away from said leverage member.

2. The device of claim 1, further comprising said handle having a channel extending therethrough between a front surface and a rear surface of said handle, said channel being configured to facilitate hanging of said device on a support member.

3. The device of claim 1, further comprising wherein said blade includes a plurality of spaced projections positioned distally relative to shaft, said spaced projections defining a notch between each of said spaced projections.

4. The device of claim 3, further comprising said plurality of spaced projections including exactly two of said spaced projections, each of said spaced projections having a respective inner lateral edge being convexly arcuate.

5. The device of claim 3, further comprising each of said plurality of spaced projections having a distal end with respect to said shaft, each of said spaced projections tapering outwardly toward a respective one of said distal ends.

6. The device of claim 1, further comprising said blade having a planar upper surface and a planar lower surface.

7. The device of claim 3, further comprising each of said plurality of spaced projections having a distal end with respect to said shaft, each of said distal ends being pointed.

8. The device of claim 1, further comprising wherein said leverage member is v-shaped defining a first section coupled to said shaft proximate a bottom end of said handle, a second section coupled to said shaft proximate said second end of said shaft and a juncture coupled to and extending between said first section and said second section.

9. The device of claim 8, further comprising an outer surface of said second section being planar to permit said second section to lie flat on the ground surface.

10. The device of claim 8, further comprising said juncture being arcuate.

11. A weed extraction tool device comprising:
an elongated shaft having a first end and a second end;
a handle coupled to said first end of said shaft, said handle having a channel extending therethrough between a front surface and a rear surface of said handle, said channel being configured to facilitate hanging of said device on a support member;
a blade coupled to said second end of said shaft; said blade being configured for being inserted into a ground surface for removing weeds from the ground surface, said blade having a planar upper surface and a planar lower surface, said blade including a plurality of spaced projections positioned distally relative to shaft, said spaced projections defining a notch between each of said spaced projections, said plurality of spaced projections including exactly two of said spaced projections, each of said spaced projections having a respective inner lateral edge being convexly arcuate, each of said plurality of spaced projections having a distal end with respect to said shaft, each of said spaced projections tapering outwardly toward a respective one of said distal ends, each of said distal ends being pointed;
a leverage member coupled to and extending outwardly from a rear end of said shaft, said leverage member being positioned below said handle and above said blade, said leverage member being configured to abut the ground surface to provide leverage for facilitating extraction of the weeds from the ground surface, said leverage member being v-shaped and defining a first section coupled to said shaft proximate a bottom end of said handle, a second section coupled to said shaft proximate said second end of said shaft and a juncture coupled to and extending between said first section and said second section, an outer surface of said second section being planar to permit said second section to lie flat on the ground surface, said juncture being arcuate; and
wherein said blade is angled downwardly and forwardly away from said shaft in a direction away from said leverage member.
